(19) United States
(12) Patent Application Publication
(10) Pub. No.: US 2004/0143838 A1
(43) Pub. Date: Jul. 22, 2004

(54) Video access management system

(76) Inventor: Mark Rose, Dallas, TX (US)

Correspondence Address: HOWISON & ARNOTT, L.L.P, P.O. BOX 741715, DALLAS, TX, 75374-1715, US

(21) Appl. No.: 10/346,531

(22) Filed: Jan. 17, 2003

(51) Int. Cl. H04N 7/16

(52) U.S. Cl. 725/25; 725/28; 725/29; 725/37

(57) ABSTRACT

A video access management system includes a video access manager having a video input and a video output. A video source providing a video signal is connected to said video input of the video access manager. A television is connected to said video output of the video access manager. The video access manager is programmed to define user viewing limits such that when a user viewing limit has been reached, the video access manager blocks the video signal from the television.

### TECHNICAL FIELD OF THE INVENTION

This invention is related to the field of video systems, in particular video access management.

### BACKGROUND OF THE INVENTION

Video entertainment, whether as television signals delivered through a satellite dish, coaxial cable or RF transmissions, recorded movies and video game systems, have become a staple in many households. One concern has become controlling access to video entertainment, in particular for children. A parent can only supervise the viewing habits of their children when the parent is present to oversee.

Therefore; what is needed is an automated system to limit access to video entertainment for individual users.

### SUMMARY OF THE INVENTION

The present invention disclosed and claimed herein, in one aspect thereof, comprises a video access management system includes a video access manager having a video input and a video output. A video source providing a video signal is connected to said video input of the video access manager. A television is connected to said video output of the video access manager. The video access manager is programmed to define user viewing limits such that when a user viewing limit has been reached, the video access manager blocks the video signal from the television.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates the video access management system;

FIG. 2 illustrates a rear view of a video access manager;

FIG. 3 illustrates a side view of a video access manager;

FIG. 4 illustrates a back plate of a video access manager;

FIG. 5 illustrates a front plate of a video access manager;

FIG. 6 illustrates an infrared remote control;

FIG. 7 illustrates a networked video access management system;

FIGS. 8a and 8b illustrate an initialization routine for a video access manager;

FIG. 9 illustrates a system initialization screen;

FIG. 10 illustrates a system initialization user definition screen;

FIG. 11 illustrates a profile saved screen;

FIG. 12 illustrates a user login screen;

FIG. 13 illustrates a time remaining screen;

FIG. 14 illustrates a limit reached screen;

FIG. 15 illustrates an admin screen

FIG. 16 illustrates a create user profile screen;

FIG. 17 illustrates a general viewing limits screen;

FIG. 18 illustrates a copy user profile screen;

FIG. 19 illustrates a delete user profile screen;

FIG. 20 illustrates an advanced screen;

FIG. 21 illustrates a rating restriction screen;

FIG. 22 illustrates a category restriction screen;

FIG. 23 illustrates a category restriction schedule screen;

FIG. 24 illustrates a day-of-week restriction screen;

FIG. 25 illustrates a restricted schedule screen;

FIG. 26 illustrates a calendar restriction screen;

FIG. 27 illustrates a calendar schedule screen;

FIG. 28 illustrates a content restriction screen;

FIG. 29 illustrates a channel restrictions screen;

FIG. 30 illustrates a channel restriction schedule screen;

FIG. 31 illustrates a warning restriction screen;

FIG. 32 illustrates a percentage restriction screen;

FIG. 33 illustrates a percentage restriction schedule;

FIG. 34 illustrates user data screen;

FIG. 35 illustrates a time balances screen;

FIG. 36 illustrates a restricted schedule screen;

FIG. 37 illustrates an admin global screen;

FIG. 38 illustrates an admin extended privileges screen;

FIG. 39 illustrates an admin cumulative viewing screen;

FIG. 40 illustrates a remote video access management system;

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

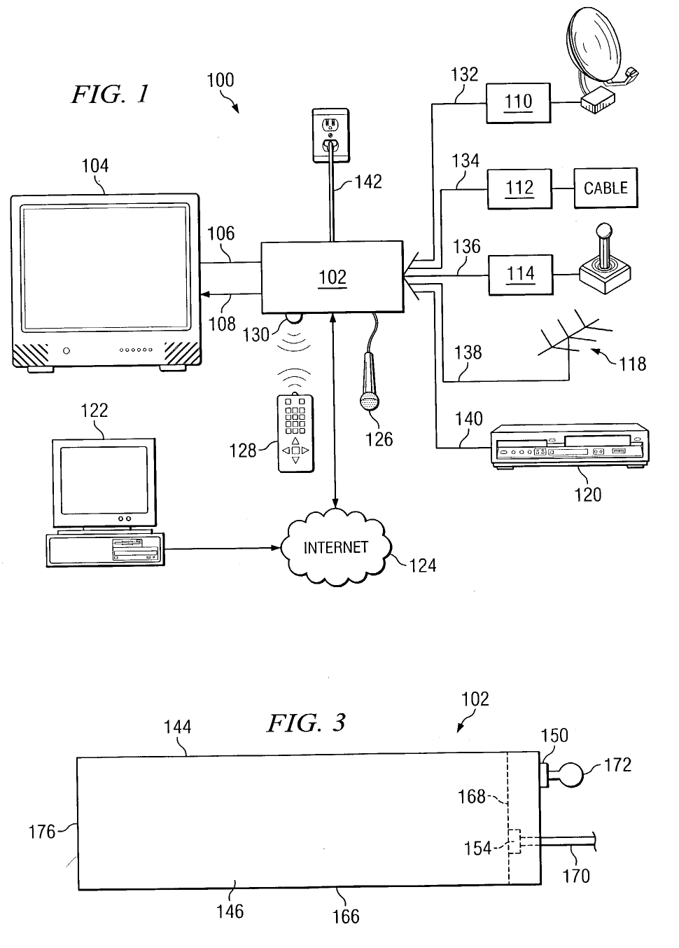

FIG. 1 depicts a functional diagram of a video access management system 100. While the video access manager 102 is shown as a separate component, it will be understood by those having skill in the art that the video access manager 102 could be integrated into the television 104, the satellite receiver 110, the cable box 112 or the video game system 114. In some implementations, the functions could be performed by more than one component working conjunctively.

Video access manager 102 is connected to a variety of video inputs devices. The video access manager 102 is also connected to a video output device such as a television 104. Television 104 receives video signal transmitted on input line 108. Input line 108 may be a coaxial cable, audio video inputs, or an S-video input. It will be apparent to those having skill in the art that a variety of methods can be used to transmit video signals from one device to another.

Television 104 operates using AC power supplied via AC power cord 106. In accordance with the preferred embodiment, the AC power cord 106 of television 104 is connected to the video access manager 102. The video input line 108 is connected to the video access manager 102, so that all video signals supplied to the television 104 is transmitted through the video access manager 102.

A variety of video inputs may be connected to the video access manager 102. For example, a satellite receiver 110 may supply signals by line 132. A cable box 112 may supply cable video signals on line 134. Video game system 114 supplies a video game signal on line 136. Television antenna 118 may supply RF television signals along line 138. Recorded video devices such as a DVD or VCR 120 may supply video signals on line 140. Satellite receiver 110 may be a digital satellite receiver or an analog satellite receiver.

Each of the video signals sent on lines 132, 134, 136, 138, and 140 may be connected directly to video input connectors on the video access manager 102. In accordance with another embodiment, some or all of the input lines may be connected to another device such a VCR. In this case, the device's video output would be connected to the video access manager 103. In such a case, the satellite video line 132, the cable video line 134, the video game line 136 and the RF line 138 could be connected to the VCR 120 so that a single video input 140 is connected to the video access manager 102. As well the variety of video devices may incorporate functions and features of other devices. For example, the game machine 114 may include a DVD function. In accordance with another aspect of the invention, the video access manager or some of the video access managers functions could be incorporated in one of the devices, in particular the cable box.

The video access manager 102 may further be connected to such input devices as a microphone 126 and an infrared remote control 128. To communicate with the infrared remote control 128, an infrared receiver 130 may be present in the video access manager 102.

Video access manager 102 may also include a modem (not shown) to allow connection to the Internet 124. Via the Internet 124, one or more personal computers 122 may be able to access data in or program the video access manager 102.

In some cases, personal computer 122 could be directly connected to the video access manager 102, rather than connected via the Internet 124.

The video access manager 102 receives power from AC power supply cord 142.

In principle, the video access manager 102 monitors the use of the video inputs by various users of the system. The video access manager is programmed with user profiles. Each profile defines viewing restrictions that apply to an individual user. When the video access manager is activated, it determines, either through login or biometric data such as vocal analysis, the presence of a user. If the user is able to view video entertainment, in accordance with the variety of restrictions that may be imposed on them, the video access manager permits viewing until a restricted status is reached. At this point, access to the television, or to certain video inputs, will be restricted.

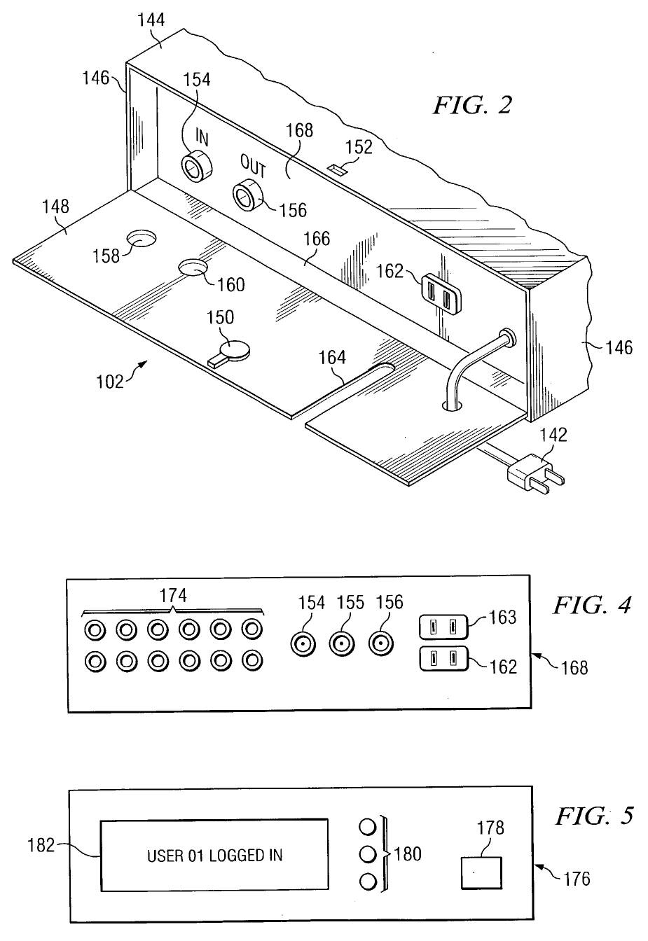

FIG. 2 depicts a configuration for the rear side of the video access manager 102. A back plate 168 is connected to a top plate 144. In accordance with one embodiment, the top plate 144 overhangs the back plate 168, creating a secure space at the rear of the video access manager 102. The secure space allows the connection of video inputs and outputs, as well as AC cords, to the video access manager in such a way that the connections cannot be easily accomplished absent the proper key. Similarly, a base plate 166 with an overhang is connected to the back plate 168. A security plate 148 is connected in a hinged fashion to base plate 166. Security plate 148 may include a lock mechanism 150. Lock mechanism 150 may be locked to engage lock slot 152 in top panel 144. Depending on the level of security necessary or desired by various users of the system, the lock security mechanism may be enhanced to include further security devices and systems. For normal home use, a simple lock may suffice.

The back plate 168 of the video access manager 102 may include a video input signal connector 154. A video output signal connector 156 is also provided. When a coaxial or other cable is connected to the video input signal connector 154, the cable 170 passes through the security plate 148 through a video input through slot 158. The coaxial cable connected to video signal output connector 156 similarly passes through a video output signal through slot 160. Switched AC outlet 162 allows external devices such as the satellite receiver 110 or cable box 112 to have their power connected directly into the video access manager 102. By using a switched AC outlet 162 the video access manager 102 can cut power to any one of the devices. The AC cord connected to AC outlet 162 passes through the security panel through AC power cord throughslot 164.

FIG. 3 depicts a side view of the video access manager 102. The face plate 176 is connected to side plates 146, top plate 144 and bottom plate 166. The back panel 168 as shown creates a recess space when the security panel 148 is closed. Lock 150 is engaged using key 172 in a standard fashion. Video input cable 170 passes through the video input signal throughslot 158 for connection with video input signal connector 154.

FIG. 4 depicts an alternative embodiment of back plate 168, in particular the power and video connections. Audio video connections 174 allow the connection of a variety of input devices. In addition to a first video input connector 154, the video access manager 102 may include a second video input connector 155. As well additional switched AC power outlets 163 may be used to switch more than one video input device's power. It will be apparent to those having skill in the art that the number of inputs, outputs and AC outlets may vary depending on the implantation.

FIG. 5 depicts a configuration of the face plate 176 of the video access manager 102. A power switch 178 allows a user to turn on and off the video access manager 102. A set of programming buttons 180 allow the user to program the various functions of the video access manager 102 from the face plate 176. A LCD digital display 182 allows various information to be displayed on the face of the video access manager 102.

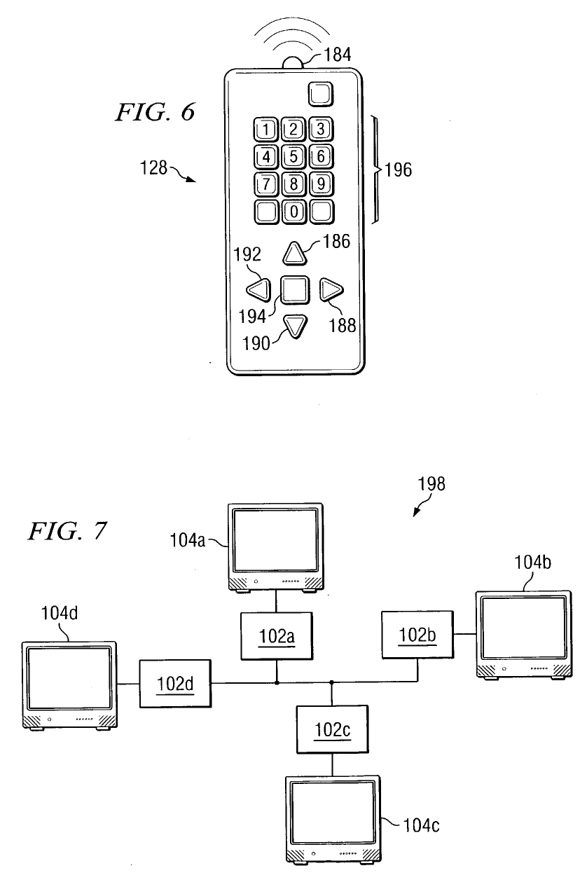

FIG. 6 depicts a standard infrared television remote 128. The remote includes an infrared transmitter 184, a set of numbered buttons 196 and cursor keys including up button 186, right button 188, down button 190, left button 192 and a select or enter button 194. The cursor buttons in particular are used to program the video access manager 102.

FIG. 7 depicts a network configuration for the video access manager 102. The video access managers 102A, 102B, 102C and 102D are connected via a local area network or similar networking system, allowing them to communicate data to each other. Each of the video access managers 102 is connected to a corresponding television 104. Using this configuration, if a user watches television on televison 104C, the time is logged by video access manager 102C. The data logged in video access manager 102C is then communicated to each of the other video access managers 102A, 102B and 102D. In this fashion, when a user changes location to watch video entertainment on television 104A, the time logged at the 104C television is compiled with the time watched on the 104A television.

A video access manager 102 receives the input from a variety of video sources. The video access manager 102 is programmed to manage the video access of a variety of users. The video access manager 102 could also be used for a single individual. The video access manager 102 stores profiles for each of the users assigning the user's age and daily, monthly and weekly limits to their video access. More advanced programming functions may also be used to limit the access of each individual user in a variety of ways.

For example, the parents in a household may be defined as users 01 and 02. They may self-impose limits on their own video viewing. More importantly, however, the parents have the ability to control the video access of each of the children in their house. A child could be limited to the number of hours they watch TV each day, each week, and each month. In this way a parent has control over the video access of their children whether or not the parents are at home to oversee the children's television viewing.

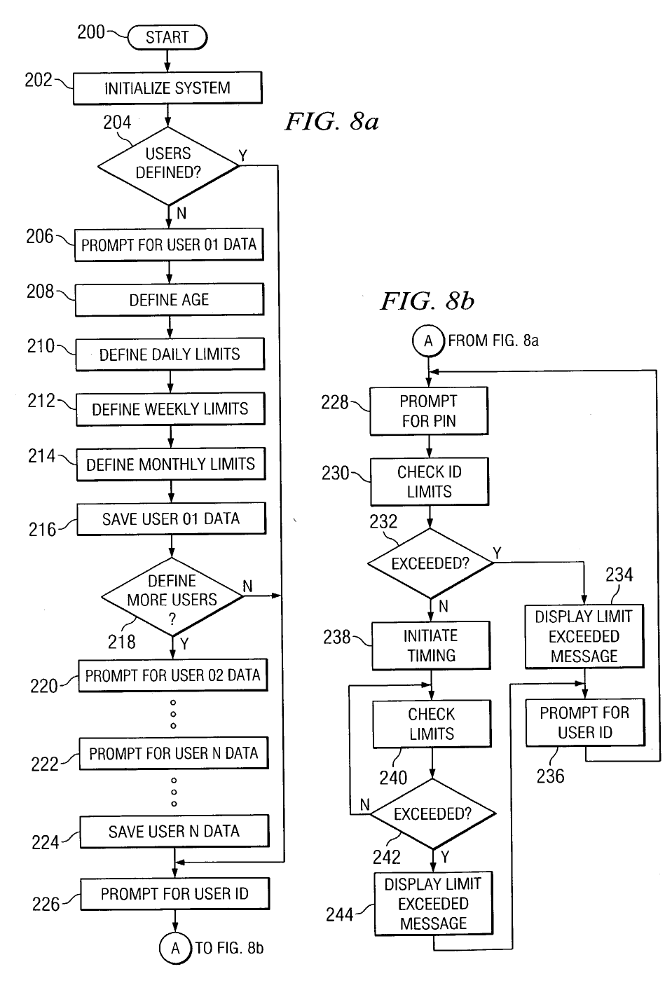

FIGS. 8A and 8B depict an initialization routine for the video access manager 102. The routine begins in step 200 with the power up of the video access manager 102. The system is initialized in step 202. The video access manager 102 loads data files from its memory. The video access manager 102 then determines if user profiles have been saved in the system in step 204. If there are no user profiles in memory, then the video access manager prompts the user for initial user data. The user is prompted to define the age of the first user in step 208. The user is then prompted to define the daily limits for the first user in step 210. The user is prompted to define weekly video limits in step 212. The user is prompted to define monthly video limits in step 214. This initial data is then saved in the video access manager 102 in step 216. The user is then prompted with the choice of defining more users at this time or proceeding with the routine. If the user desires to define further users at this time, then the user is prompted in a similar fashion for the second user's data in step 220 up to an nth user in step 222. The user data is then saved in step 224. If the initial users have previously been defined or all the users have been defined and saved in the initialization, the video access manager 102 prompts the user for the user ID of the user who intends to use the video system. In step 228, the user is prompted for a personal identification number. In accordance with the preferred embodiment, each user is prompted to select their own unique pin to securely define their presence on the system. In some embodiments, a PIN may not be necessary, for example if voice recognition were used.

Once the user has been logged in, the video access manager 102 checks the daily, monthly and weekly limits of that particular user in step 230. If any of those limits have been exceeded in step 232, the video access manager 102 will display a limit exceeded message in step 234. With the limit exceeded message, the video access manager 102 prevents that particular user is unable to use the television 104. The video access manager 102 will then prompt for another user ID in step 236. When the user ID has been entered, the routine then returns to prompt for a personal identification number. If the video limits for that particular user have not been exceeded, then the video access manager 102 initiates timing of the particular video session in step 238. As the television 104 is being used, the limits are continuously being checked by the video access manager in step 240. When the limits have been exceeded in step 242, a limit exceeded message will be displayed in step 244 and again the video access manager 102 will prompt for a new user ID in step 230. The video access manager 102 may use one of several display methods. The video access manager 102 may display programming prompts as well as reports. The video access manager 102 may display information using the LCD screen 182 on the face plate of the video access manager 102. In a preferred embodiment, the information may be displayed using the television 104 as a display device. In this case, the video access manager 102 generates a video signal that is sent to the television 104 on lines 108. If the video access manager 102 is connected to personal computer 122 via a direct connection or a network connection, the information may be displayed on the personal computer 122's video monitor. Other display devices may be incorporated as seems suitable for the implementation.

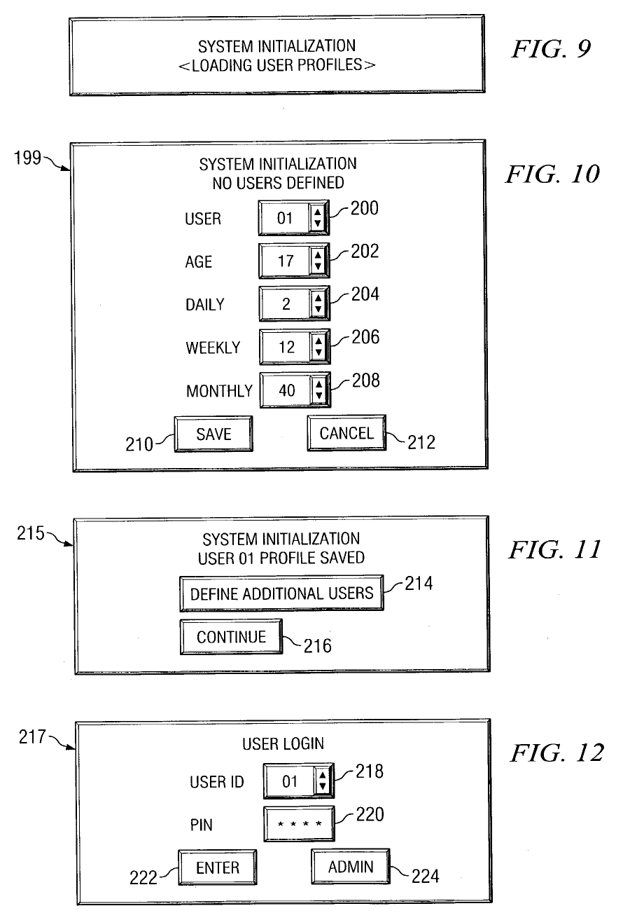

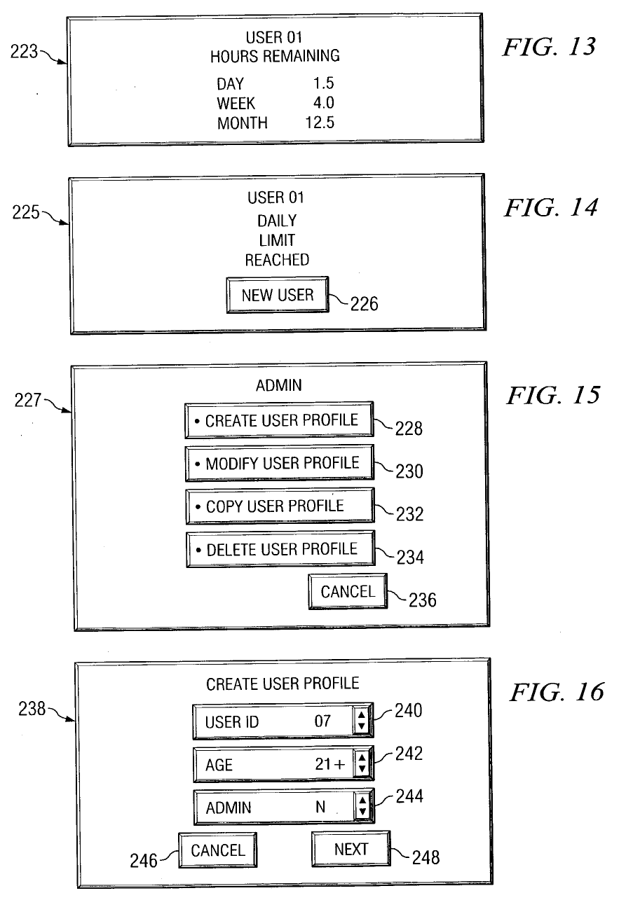

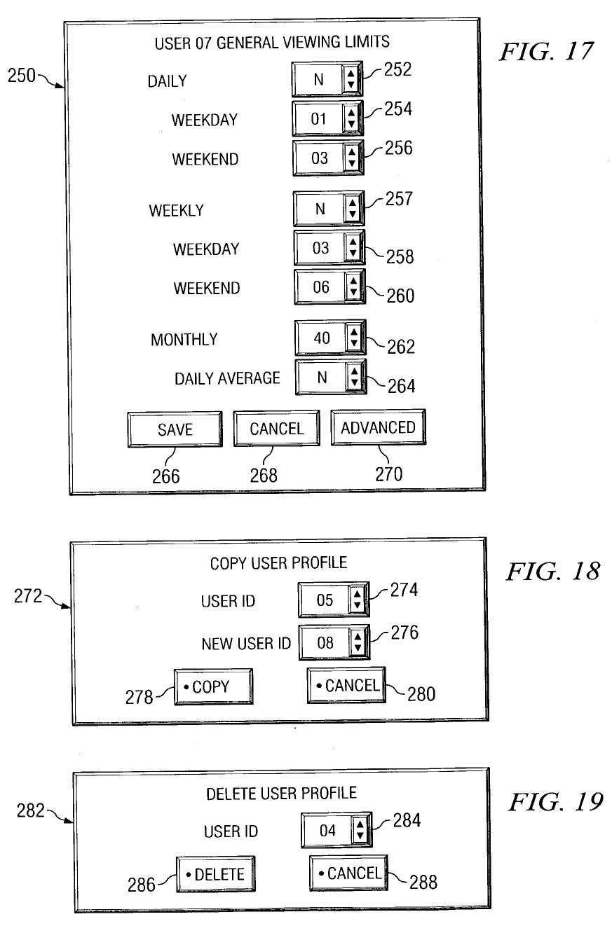

FIG. 9 depicts a first display screen. The display screen in FIG. 9 is a system initialization screen and shows that the loader that is loading user profiles.

With reference to FIG. 10, once the user profiles have been loaded, the video access manager 102 determines if users have previously been defined. If no users have been defined, the system initialization user definition screen 199 is displayed. When the system initialization user definition screen 199 is presented, the user is shown a variety of selectable fields.

Many of the screens that may be presented by the video access manager include selectable fields. The information in the selectable fields is manipulated using the programming buttoms 180 on the face plate 176 of the video access manager 102. The selectable fields may also be manipulated using the cursor keys on the infrared remote 128. Where the screens are displayed on a personal computer 122, the information may be entered using the keyboard and mouse of the personal computer 122.

A selectable field is the USER ID field 200. In accordance with the preferred embodiment, the USER ID field 200 will default to the lowest available user number. The user number may be changed using the up and down buttons on the remote or face plate of the video access manager. Another user selectable field is the AGE field 202. Similarly, the age may be increased or decreased using the up and down buttoms on the various input devices.

The third user selectable field is the DAILY LIMIT field 204. In a similar fashion, the DAILY LIMIT field may be increased or decreased. Another selectable field is the WEEKLY LIMIT field 206. A MONTHLY LIMIT field 208 may also be available. Depending on the particular implementation, one or more of these fields may not be available. As well, depending on the implementation, additional data for the user profile may be collected at this point. When the user has finished entering the data, the user may then select the SAVE field 210 or the CANCEL field 212. When the SAVE field 210 is selected, the user profile is saved.

FIG. 11 depicts the system initialization user profile save screen. The profile save screen displays the information that the user profile created on the previous screen has in fact been saved. The user profile save screen includes a selectable field 214 to select the option of defining additional users in the system during the initialization. Otherwise, a selectable field 216 to continue is provided.

If the user selects the DEFINE ADDITIONAL USERS selectable field 214, the user is directed back to the system initialization user definition of FIG. 10.

If the CONTINUE field is selected, the user is prompted by a user log in screen as shown in FIG. 12. The user log in screen includes a USER ID selectable field 218. The USER ID selectable field allows the user to select the user ID number of the user that is logging into the system. A pin number is entered into the selectable field 220. The pin number assigned elsewhere, identifies the user to the system. When the user ID has been selected and the pin number entered, the user selects either an enter field 222 or an administration field 224. If the user has the correct pin and administration privileges, they are allowed to go the administration screens. Otherwise, the enter field is the only one that is selectable.

When the ENTER field 222 of the user log in screen has been selected, the user is presented with a display of the time remaining to the user in the basic groups of daily, weekly and monthly limits. In the present example, the user has 11 hours remaining for that particular day, 4 hours remaining for the week and 12.5 hours remaining for the month.

If any of those limits has been reached, the user is presented with a display informing them that their limit has been reached. Similarly, if during the time while they are viewing the television, any of those limits are reached, the television will be turned off and made inaccessible and the user is presented with a notification that their limit has been reached. If another user desires to use the television, the new use field is selected.

If multiple users are present, each of the users is required to login to the system. If a voice recognition system is used, the users may identify themselves to the system by speaking aloud.

When the user selects the ADMIN selectable field 224 of FIG. 12, the user is presented with an ADMIN screen 227. The ADMIN screen 227 includes several selectable fields. The ADMIN screen includes a selectable field to create a user profile 228. The ADMIN screen also includes a MODIFY USER PROFILE selectable field 230. The ADMIN screen includes a copy user profile selectable field 232. The ADMIN screen 227 includes a delete user profile selectable field 234. If the user does not desire to perform any of the functions available on the ADMIN screen, a CANCEL selectable field is also available.

When the user selects the CREATE USER PROFILE selectable field 228 in FIG. 15, the user is presented with a CREATE USER PROFILE 238 as shown in FIG. 16. The CREATE USER PROFILE SCREEN includes several selectable fields. The first user selectable field 240 is a USER ID field. The USER ID field 240 is used to select the user ID of the new user. In the preferred embodiment, the USER ID field will default to the lowest number presently available on the system. An AGE selectable field 242 is used to identify the age of the particular user. The AGE selectable field can be incremented or decremented using the input devices. An ADMIN field 244 is used to identify the administrative privileges of a particular user. The ADMIN selectable field 244 toggles between a “yes” or a “no.” If the user has decided not to create a user profile, the CANCEL selectable field 246 is selected. Otherwise, a next field 248 is used to progress to the next screen.

Other information may be stored in the user profile. Credit card information may be stored in the user profile to facilitate home shopping. In this way the video access manager 102 can be integrated into a system designed for buying products or services presented in advertising or programming content. The video access manager 102 may then define user purchase limits, including daily, weekly and monthly limits. The limits could be set for content or products by card or cumulatively. The system may also allow users to save their credit card numbers with user-defined names, like MY VISA. The credit card information would be password protected or otherwise securely stored.

When the user selects the NEXT field 248, the user is shown a GENERAL VIEWING LIMITS screen 250. The GENERALVIEWING LIMITS screen 250 includes a number of user selectable fields. The first user selectable field is a DAILY field 252. Using the DAILY field, the user can set a daily limit for the user. In the case where the weekday and weekend options are used, the DAILY field is set to N to make it non-applicable. The WEEKDAY field 254 and the WEEKEND filed 256 are used to set the weekday and weekend hourly limits appropriately. This can be used where a viewer is permitted a different amount of time on a weekday than they are on a weekend day. Another user selectable field is the WEEKLY field 257. Using the WEEKLY field 257, the user can define the number of hours that can be viewed during a week generally. In the alternative, a WEEKDAY field 258 and a WEEKEND field 260 is provided to allow for different limits for the week and weekend. Another user selectable field is the MONTHLY field 260. The MONTHLY field is used to define the number of hours that the viewer is allowed to view the television in a month period. In the alternative, a daily average can be defined which sets an average television viewing per day taking into account that all months are not equal in length. When the MONTHLY field 260 has been set, the DAILY AVERAGE field will be set at N for not applicable. In the alternative where a daily average is set in DAILY AVERAGE field 264, the MONTHLY data field 262 will default to an N status.

When the general viewing limits have been entered in the data fields provided, the user may select the SAVE field 266. The SAVE field will save the user profile as it has been outlined in the other data fields. Otherwise, the user may select the CANCEL field 268. Selecting the CANCEL field 268 will return the user to the previous screen as shown in FIG. 16. The user may also be prevented with ADVANCED field 270. The ADVANCE field will present further advance viewing limit possibilities.

When user selects the MODIFY USER PROFILE field 230, the video access manager 102 displays the USER GENERAL VIEWING LIMIT screen 250. This allows the user to modify the various fields in the user profile.

Where the user selects COPY USER PROFILE field 232, the video access manager 102 displays the COPY USER PROFILE screen 272. COPY USER PROFILE screen includes several selectable fields. A USER ID field 274 is used to select the user ID that is to be copied. A NEW USER ID field 276 is used to set the ID number for a new user. When the COPY field 278 is selected, the data from the first user ID defined in USER ID field 274 is copied to the new user ID as defined by the NEW USER ID field 276. In the alternative, the user may cancel the copy process using the CANCEL field 280.

Where the user has selected the DELETE USER PROFILE field 234, the video access manager 102 displays a DELETE USER PROFILE screen 282. The DELETE USER PROFILE screen 282 includes several user selectable fields. A USER ID field 284 is used to select the user ID that is to be deleted. When the ID has been selected, the DELETE field 286 may be used to delete the user ID from the system. In the alternative, the CANCEL field 288 may be used to cancel the delete process.

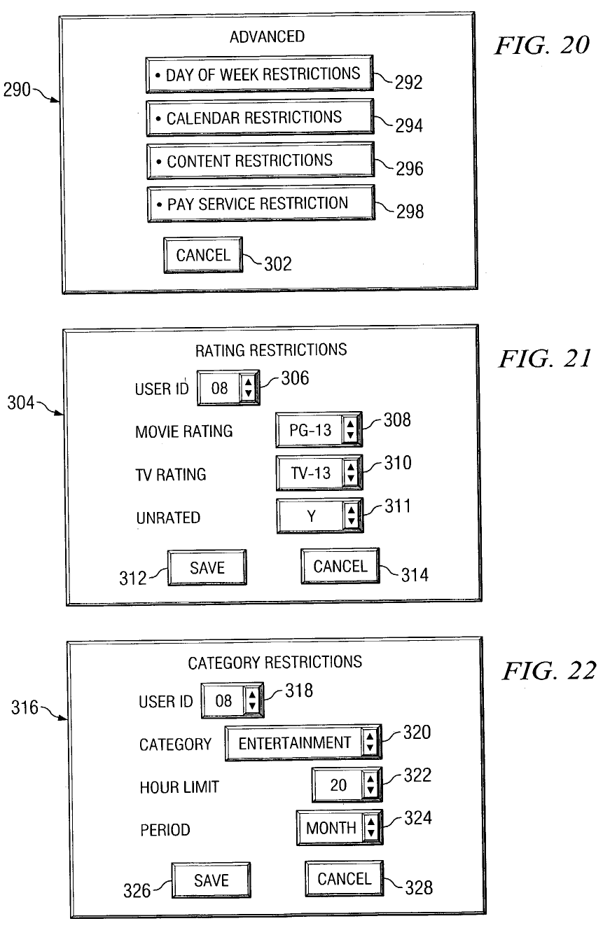

With reference to FIG. 20, where the user has selected the ADVANCE PROGRAMMING field 270, the video access manager may display an ADVANCED screen 290. The ADVANCED screen 290 includes several user selectable fields. A DAY OF THE WEEK RESTRICTIONS field 292 is used to set restrictions for each particular day of the week. A CALENDAR RESTRICTIONS field 294 is used to program specific calendar date restrictions into the system. A CONTENT RESTRICTIONS field 296 allows restriction based on the content of viewing material. A PAY SERVICE RESTRICTION field 298 is used to restrict access to pay services. A CUSTOMIZE CATEGORIZATION field 300 is used to define categories for use in restriction process. A CANCEL field 302 is used to cancel the use of the advanced programming screen.

With reference to FIG. 21, when the user has selected the DAY OF THE WEEK RESTRICTIONS field 292, a DAY OF WEEK RESTRICTIONS screen 332 is displayed by the video access manager 102. The DAY OF THE WEEK RESTRICTIONS screen includes several user selectable fields. A USER ID selectable field 334 is used to select ID that is being programmed. A DAY OF THE WEEK field 336 is used to select the day of the week for which restrictions are being applied. A START TIME selectable field 338 is used to select the start time of the restriction. An END TIME field 340 is used to select the end time of the restriction. A restriction is set to allow or disallow in selectable field 342. When the day of the week restrictions have been programmed, the SAVE field 344 is used to save the restriction. In the alternative, a CANCEL field 346 will cancel the programming.

When the user has selected the SAVE function 344, the video access manager may display a RESTRICTED SCHEDULE screen 348. The RESTRICTED SCHEDULE screen 348 includes a USER ID field 350 to select the user ID or which the restricted schedule is to be displayed. The restricted schedule screen 348, displays each of the restrictions for each of the days. Any given day may have periods of time which are allowed or disallowed in accordance with the programming set in DAY OF THE WEEK RESTRICTIONS screen. For example, in the screen shown, Monday does not allow viewing from midnight until 4 p.m. A time period from 4:01 to 6 p.m. is set so that access is allowed to this particular user during that time period. A third restricted time from 6:01 until midnight does not allow viewing in this particular case.

Where the user has selected the CALENDAR RESTRICTIONS field 294, the CALENDAR RESTRICTION screen 352 is displayed by the video access manager 102. The CALENDAR RESTRICTION screen includes several user selectable fields. A USER ID field 354 is used to select the ID of the user for which the restrictions are being applied. A DATE field 356 is used to select the date on which the restriction will be applied. A START field 358 is used to set the start time for the restriction. A STOP field 360 is used to set the stop time for the restriction. An ACCESS field 362 is used to set the restriction to either allow or disallow viewing during that time period. When the data has been entered by the user, the SAVE field 364 is used to save the restriction. In the alternative, the CANCEL field 366 is used to cancel the programming.

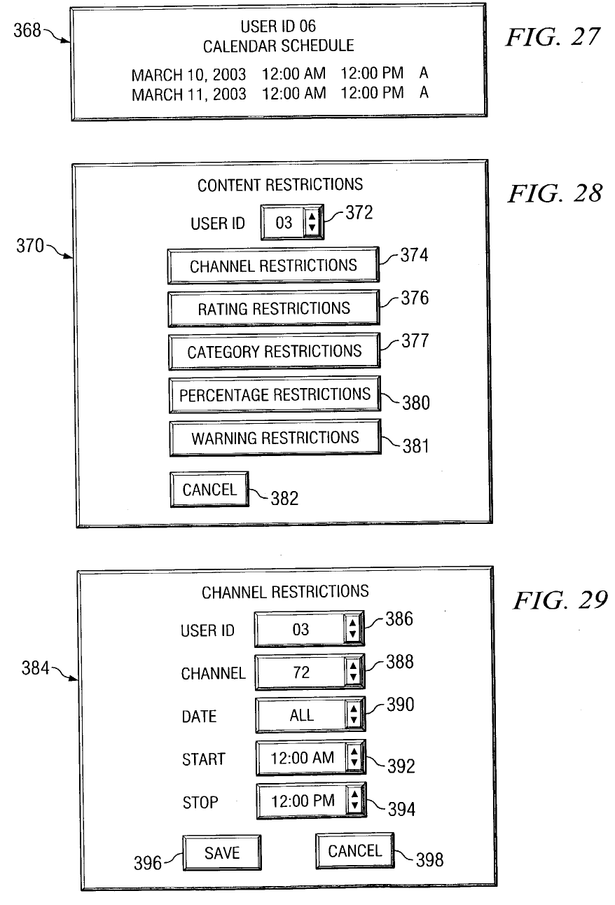

With reference to FIG. 27, when the SAVE field has been selected, the video access manager will display a calendar schedule for the particular user. In this case, the viewing is unrestricted for the dates of Mar. 10, 2003 and Mar. 11, 2003. This allows the system to change viewing access during such times as school breaks or other holidays. The calendar restrictions will supersede the daily or cumulative restrictions normally set for that particular viewer.

With reference to FIG. 28, when the user has selected the CONTENT RESTRICTIONS field 396, the video access manager 102 displays a CONTENT RESTRICTIONS screen 370. The CONTENT RESTRICTIONS screen includes several user selectable fields. A USER ID field 372 is used to set the USER ID for which the content restrictions are to applied. A CHANNEL RESTRICTION field 374 is used to set restrictions on specific channels. A RATING RESTRICTION field 376 is used to set restrictions based in ratings of television and movie programs. A CATEGORY RESTRICTION field 378 is used to set restrictions based on categories of viewing content. A PERCENTAGE RESTRICTION field 380 is used to set restrictions based on percentage of program type viewing. A WARNING RESTRICTION field 381 is used to set restrictions based on various warning labels applied to programs. A CANCEL field 382 is used when content restrictions are not going to be applied.

With reference to FIG. 29, where the CHANNEL RESTRICTION field 374 has been selected, the video access manager 102 displays a CHANNEL RESTRICTION screen 384. The CHANNEL RESTRICTION screen includes several user selectable fields. A USER ID field 386 is used to set the USER ID for which the channel restrictions are to be applied. The CHANNEL field 388 is used to set the channel for which the restriction is being applied. A DATE field 390 is used to set a specific date on which the channel restriction will be applied. A START field 392 is used to set the start time for the restriction. A STOP field 394 is used to set the stop time for restriction. When the user has entered the data into the selectable fields, the SAVE field 396 is used to save the restriction. In the alternative, the CANCEL field 398 may be used to cancel the restriction programming.

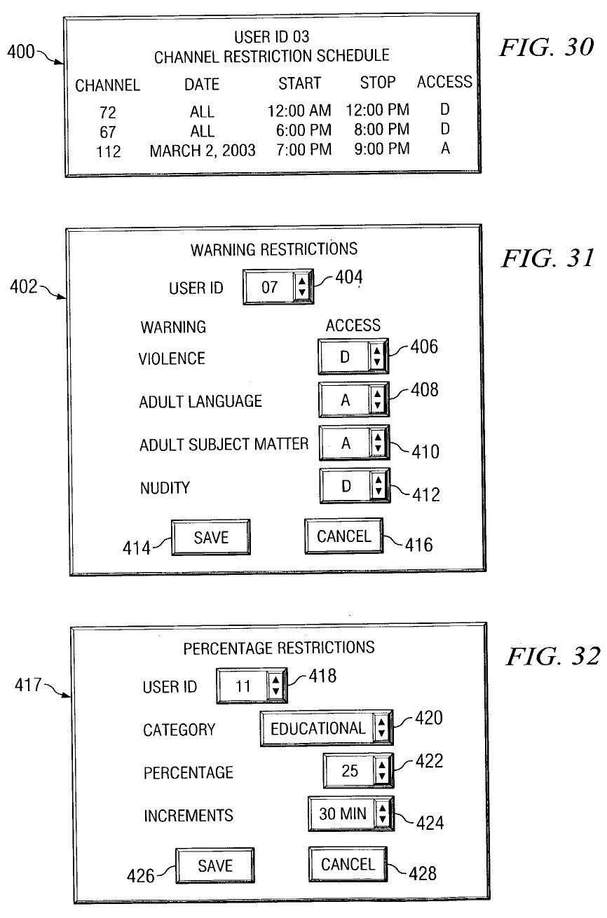

With reference to FIG. 30, where the SAVE field 396 has been selected, the video access manager 102 displays a CHANNEL RESTRICTION SCHEDULE screen 400. The CHANNEL RESTRICTION SCHEDULE screen 400 shows the restrictions for each of the channels for the particular user. In this particular instance, channel 72 is restricted at all times from viewing for this particular user. Alternatively, a channel 112 has allowed viewing on a particular time and date. This allows the user to define exceptions to the general viewing limits, so that certain channels may not be watched at all, certain programs may not be watched, or specific programs may be watched at a specific time.

With reference to FIG. 31, where the user has selected the RATING RESTRICTION field 376, the video access manager 102 will display a RATING RESTRICTIONS screen 304. RATING RESTRICTIONS screen 304 includes several user selectable fields. A USER ID field 306 is used to select the USER ID to which the restrictions will be applied. A MOVIE RATING field 308 is used to select the maximum movie rating that will be viewable by the user. A TV RATING field 310 is used to select the maximum rating allowed for the user for particular TV programs. An UNRATED field 311 is used to select whether or not unrated programs can be viewed. When the user has set the restrictions in the RATING RESTRICTIONS screen 304, the SAVE field 312 is used to save the restriction. In the alternative, a CANCEL field 314 is used to cancel the restrictions.

With reference to FIG. 22, where the user has selected the CATEGORY RESTRICTION field 378, the video access manager 102 will display a CATEGORY RESTRICTION screen 316. The CATEGORY RESTRICTION screen 316 includes several user selectable fields. A USER ID field 318 is used to set the user ID for the particular restriction. A CATEGORY field 320 is used to set restrictions on particular categories. These categories may include such things as entertainment, educational, sports or other types of programming. An HOUR LIMIT field 322 is used to set the hour limit for the particular category. The period to which the hour limit applies is set in a PERIOD field 324. When the user has entered the restriction into the fields, a SAVE field 326 is used to save the restriction. In the alternative, the CANCEL field 328 may be used to cancel the restriction.

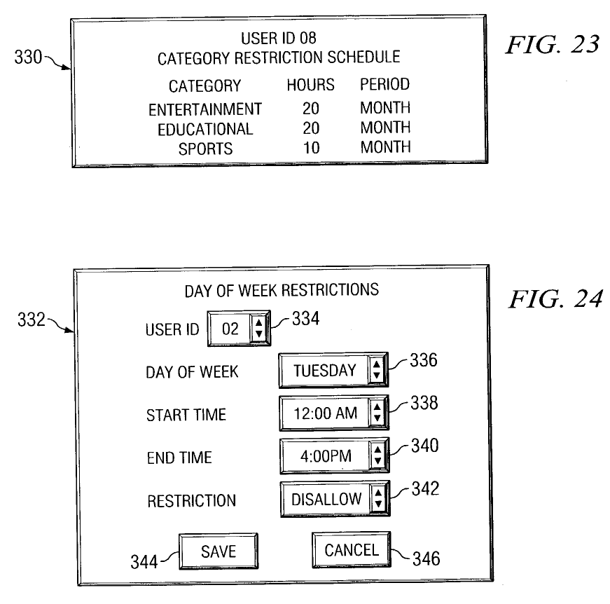

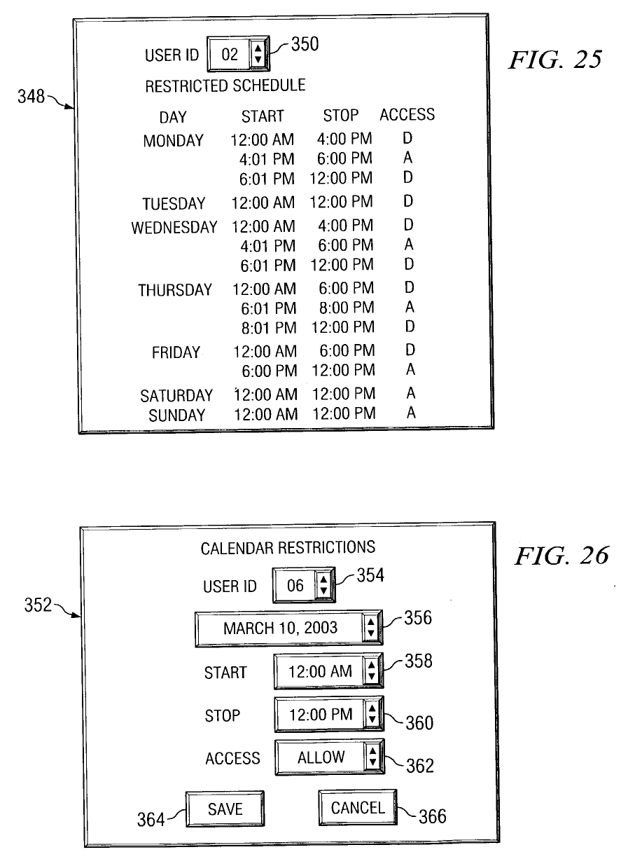

With reference to FIG. 23, where the user has selected the SAVE field 326 in the CATEGORY RESTRICTIONS screen 316, a CATEGORY RESTRICTIONS SCHEDULE 330 is presented by the video access manager 102. The CATEGORY RESTRICTIONS SCHEDULE 330 displays the restrictions for each category as set by the CATEGORY RESTRICTIONS screen 316.

With reference to FIG. 31, where the user has selected the WARNING RESTRICTION field 381, the video access manager displays a WARNING RESTRICTIONS screen 402. WARNING RESTRICTIONS screen includes several user selectable fields. A USER ID field 404 is used to set the USER ID for the particular restriction. A set of warnings as applied to various programming are outlined and fields applied to each one to allow or deny access based on those warning restrictions. For example, a VIOLENCE field 406 may be used to restrict programs that have been labeled as violent. An ADULT LANGUAGE field 408 is used to restrict access to programming that includes an adult language warning. An ADULT SUBJECT MATTER field 410 is used to restrict access to programming that has been labeled adult subject matter. A NUDITY field 412 is used to restrict access to programming that has a nudity warning. When the user has set the restrictions in the various fields, the SAVE field 414 is used to save the restriction. In the alternative, the CANCEL field 416 may be used to cancel the restrictions programming.

With reference to FIG. 32, where the user has selected the USER RESTRICTIONS field 380, the video access manager 102, displays a PERCENTAGE RESTRICTION screen 417. PERCENTAGE RESTRICTION screen 417 screen includes a number of user selectable fields. A USER ID field 418 is used to select the user ID that the restrictions will be applied. CATEGORY field 420 is used to select the category for which the restriction is going to be applied. A PERCENTAGE field 422 is used to set the percentage of viewing time that must be spent watching a particular category. An INCREMENT field 424 is used to select the maximum increment by which the percentages of time viewed may vary. When the restrictions have been set, a SAVE field 426 is selected to save the restriction in the user profile. In the alternative, a CANCEL field 428 is used to cancel the restriction.

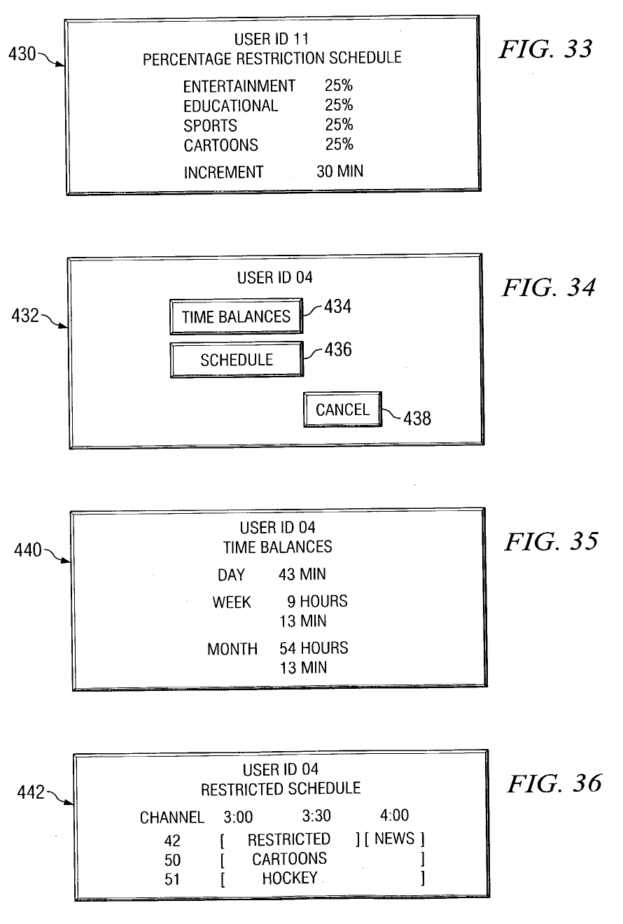

With reference to FIG. 33, when the SAVE field 426 has been selected in the PERCENTAGE RESTRICTION screen 417, a PERCENTAGE RESTRICTION SCHEDULE screen 430 is displayed by the video access manager 102. The PERCENTAGE RESTRICTION SCHEDULE shows the USER ID to which the restriction applies and the percentage of viewing time that may be spent watching each of the particular categories. The PERCENTAGE RESTRICTION SCHEDULE screen 430 also shows the increment of time at which the percentages may be varied. In this fashion, no one of the categories may be viewed for more than 30 minutes more than another category.

With reference to FIG. 34, a USER DATA screen 432 is displayed. The USER DATA screen 432 includes several user selectable fields. A TIME BALANCE field 434 allows the user to view their time balances. A SCHEDULE field 436 is used to view the user's customized schedule. A CANCEL field 438 is used to return the system to a viewing mode.

With reference to FIG. 35, where the user has selected the TIME BALANCES field 434, a TIME BALANCE screen 440 is displayed. The TIME BALANCE screen displays the time remaining in each of the periods as well as other programmed categories and restrictions.

With reference to FIG. 36, where the SCHEDULE field 436 has been selected, the video access manager 102 displays a RESTRICTED SCHEDULE DISPLAY screen 442. The RESTRICTED SCHEDULE DISPLAY screen 442 displays only the channels for which the particular user is allowed access and displays the programming that is available to the user on those channels. In this way, a particular user may know exactly what is on the television that may be viewed without showing programming that cannot be watched.

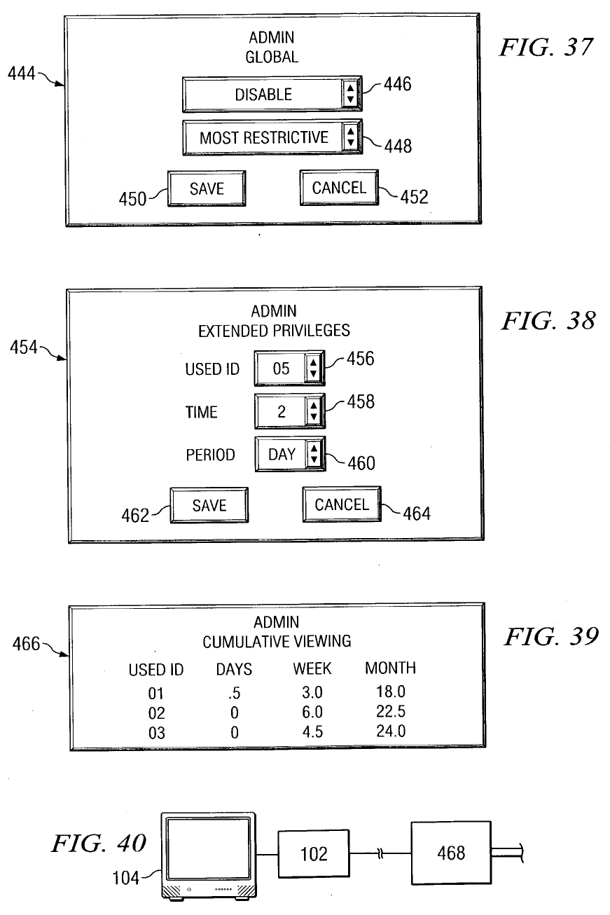

With respect to FIG. 37 where the ADMIN field 224 has been selected, a GLOBAL ADMIN screen 444 is displayed. The GLOBAL ADMIN screen 444 includes several user selectable fields. A DISABLE field 446 allows the user to disable the entire video access manager. A RATING RESTRICTION field 448 is used to define whether the most restrictive viewing access or least restrictive viewing access will be applied to all users. The most restrictive viewing access selection denies access to any viewer if it would be denied to one of the users. The least restrictive viewing access selection allows access to any view if it is allowed to one of the users. When the global restrictions have been set, they may be saved by selected the SAVE field 450. Otherwise, the CANCEL field 452 may be used to cancel the restrictions.

With reference to FIG. 38, an EXTENDED PRIVILEGES screen 454 is shown. The EXTENDED PRIVILEGES screen includes several user selectable fields. A USER ID field 456 is used to select the user for which the extended privileges are being allowed. A TIME field 458 is used to define the amount of time to which the user has extended privileges. A PERIOD field 460 is used to define the period during which the time defined in TIME FIELD 458 may be used. When the restrictions have been set, the restriction may be saved using the SAVE field 462. Otherwise, a CANCEL field 464 is selected to cancel the extended privileges.

The video access manager may also generate one or more reports available to users with ADMIN privileges. With reference to FIG. 9, a CUMULATIVE VIEWING screen 466 is shown. The CUMULATIVE VIEWING screen 466 displays the time remaining for each of the users. Other data may be shown as well. Where the video access manager 102 is connected to the Internet, the CUMULATIVE VIEWING screen 466 may be fashioned as a report which is sent by e-mail to any defined recipient.

With reference to FIG. 40, a video access manager system is shown connected to a cable box 468 at the cable station. While in the preferred embodiment, the functionality and memory for the video access management is performed entirely by the video access manager 102. In an alternative embodiment, the user profiles may be stored at the cable processor 468, while the processing functions are performed in a video access manager 102.

Although the preferred embodiment has been described in detail, it should be understood that various changes, substitutions and alterations can be made therein without departing from the spirit and scope of the invention as defined by the appended claims.

What is claimed is:

1 A video access management system comprising:
a video access manager having a video input and a video output;
a video source providing a video signal connected to said video input of the video access manager;
a video monitor connected to said video output of the video access manager;
wherein said video access manager is programmed to define user viewing limits such that when a user viewing limit has been reached, the video access manager blocks the video signal to the video monitor.

2 The video access management system of Claim 1 wherein said video access manager is programmed to define user viewing limits for more than one user.

3 The video access management system of Claim 1, wherein said user viewing limits include a time-based viewing limit.

4 The video access management system of Claim 1, wherein said video source is a satellite receiver.

5 The video access management system of Claim 1, wherein said video source is a cable box.

6 The video access management system of Claim 1, wherein said video source is a video game system.

7 The video access management system of Claim 1, wherein said video source is a recorded video player.

8 The video access management system of Claim 3 wherein said time-based viewing limit defines a daily viewing limit.

9 The video access management system of Claim 1 wherein said user viewing limits include a content-based viewing limit.

10 The video access management system of Claim 1 further comprising a personal computer connected to the video access manager.

11 The video access management system of Claim 10, wherein said personal computer sends programming signals to the video access manager to program the user viewing limits in the video access manager.

12 The video access management system of Claim 10, wherein said video access manager sends reports to the personal computer.

13 The video access management system of Claim 10, wherein said personal computer is connected to the video access manager through a network.

14 A video access management system comprising:
a first video access manager having a first video input and a first video output;
a second video access manager having a second video input and first video output, connected to said first video access manager;
a first video source providing a first video signal, connected to said first video input of the first video access manager;
a second video source providing a second video signal connected to said second video input of the second video access manager;
a first video monitor connected to said first video output of the first video access manager;
a second video monitor connected to said second video output of the second video access manager;
wherein said first video access manager is programmed to define user viewing limits such that when a user viewing limit has been reached, the first video access manager blocks the first video signal from the first video monitor and the second video access manager blocks the second video signal from the second video monitor.

15 The video access management system of Claim 14 wherein said first video access manager is programmed to define user viewing limits for more than one user.

16 The video access management system of Claim 14, wherein said user viewing limits include a time-based viewing limit.

17 The video access management system of Claim 14, wherein said first video source is a satellite receiver.

18 The video access management system of Claim 14, wherein said first video source is a cable box.

19 The video access management system of Claim 14, wherein said first video source is a video game system.

20 The video access management system of Claim 14, wherein said first video source is a recorded video player.

21 The video access management system of Claim 16 wherein said time-based viewing limit defines a daily viewing limit.

22 The video access management system of Claim 14 wherein said user viewing limits include a content-based viewing limit.

23 The video access management system of Claim 14 further comprising a personal computer connected to said first video access manager.

24 The video access management system of Claim 23, wherein said personal computer sends programming signals to said first video access manager to program the user viewing limits in said first video access manager.

25 The video access management system of Claim 23, wherein said first video access manager sends reports to the personal computer.

26 The video access management system of Claim 14, wherein said first video source and said second video source are a single video source providing video signals to both the first and second video access managers.

27 The video access management system of Claim 23, wherein said personal computer is connected to the video access manager through a network.
